(19) United States
(12) Patent Application Publication
(10) Pub. No.: US 2025/0387990 A1
(43) Pub. Date: Dec. 25, 2025

(54) METHOD FOR PRODUCING PRE-INSULATED FITTINGS

(71) Applicant: Georg Fischer Rohrleitungssysteme AG, Schaffhausen (CH)

(72) Inventors: Daniel JETTÉ, Oakville (CA); Frank WISSLER, Öhningen (DE); Oliver MURBACH, Thayungen (CH)

(21) Appl. No.: 19/247,036

(22) Filed: Jun. 24, 2025

(30) Foreign Application Priority Data
Jun. 25, 2024 (EP) 24184151.9

(51) Int. Cl. B29D 23/00; B29K 75/00; B29K 105/04; F16L 59/14

(52) U.S. Cl. CPC B29D 23/003; F16L 59/143; B29K 2075/00; B29K 2105/04

(57) ABSTRACT

A method for producing a pre-insulated fitting including providing a mould, wherein the mould has open end faces and an inner contour, wherein the inner contour corresponds to the fitting outer contour of a pre-insulated fitting including applying a coating to the inner contour, wherein the applied coating, after demoulding, forms the outer jacket of the pre-insulated fitting. Then, installing a fitting internally in the mould, wherein the internal fitting forms the fitting through which medium flows in the pre-insulated fitting. Closing the end faces of the mould by means of closure caps. Introducing a liquid insulating material into the cavity formed between the inner contour of the mould, the closure caps and the internal fitting, and removing the mould and the closure caps.

### CROSS-REFERENCE TO RELATED APPLICATIONS

This application claims the benefit and priority of European Patent Application No. 24184151.9, filed Jun. 25, 2024. The entire disclosure of the above application is incorporated herein by reference.

### BACKGROUND OF THE INVENTION

### Technical Field

The invention relates to a method for producing a pre-insulated fitting and to the pre-insulated fitting itself, comprising:
providing a mould,
installing a fitting internally in the mould,
introducing a liquid insulating material into the cavity that has been formed, and
removing the mould.

### Discussion

In applications in which good insulation of the medium in the pipeline with respect to the environmental conditions is required, pre-insulated pipelines are used in most cases. For example, such pre-insulated pipelines are used for transport in the case of refrigerant media. In most cases, an insulating insulation layer is arranged around the pipe transporting the medium, said insulation layer being surrounded by an outer skin, which serves to protect the insulation layer from external influences such as, for example, moisture. The outer jacket can be formed by a concentrically arranged outer pipe.

The connection of such pre-insulated pipelines is correspondingly complex, since the insulation must first be removed from the ends that are to be connected and, after connection with a pipe-connecting moulding, the insulation must be applied again manually.

EP 1 909 018 B1 discloses a pipe joint moulding with thermal insulation. When this pipe joint moulding is applied, insulation is no longer necessary after installation in the pipeline system, since the insulation is already arranged on the pipe joint moulding, with the result that effort in terms of subsequent insulation can be saved. In order to produce the pipe joint moulding, the inner pipe is first placed into a mould, in which it is then embedded in the insulating foam. It is subsequently placed into a second mould, in which the insulation layer is subsequently encapsulated with the plastics material of the outer jacket. It is a disadvantage that this method can be implemented only for pipe joint mouldings up to a diameter of 225 mm.

In the case of fittings with a diameter of the inner fitting of greater than or equal to 250 mm, the pre-insulated fitting has hitherto been composed of, or welded together from, existing pipes. To this end, a polyethylene pipe for the outer jacket is cut into pipe segments, which are then welded together to form a fitting outer jacket into which the internal fitting is inserted and fastened. The end faces are then closed by closure elements and the insulating material is injected into the gap between the outer jacket, formed of segments, and the internal fitting, and cured. Following which the closure elements are removed and finishing of the pre-insulated fitting is carried out.

This production method has the disadvantage that a pre-insulated fitting has an outer jacket that has a solid wall thickness, since the outer jacket has been welded together from conventional pipes and the wall thickness is not required for use as a pre-insulated fitting. The solid wall thickness is required solely for transporting and storing the pipes beforehand, so that excessive deformation of the pipes does not occur. In addition, cutting the pipe segments to size results in a large amount of unusable pipe waste, and production is also very time-intensive. This all entails high production costs for a pre-insulated fitting.

One aspect of the invention is to propose a method for producing a pre-insulated fitting, and a pre-insulated fitting, which permits economical production for pre-insulated fittings for large dimensions and wherein the fitting is not over-dimensioned for its use, and production is reproducible and the pre-insulated fittings are always identical.

### SUMMARY

This aspect is achieved in that the method for producing a pre-insulated fitting comprises:
providing a mould, wherein the mould has open end faces and an inner contour, wherein the inner contour corresponds to a fitting outer contour of the pre-insulated fitting,
applying a coating to the inner contour, wherein the applied coating, after demoulding, forms the outer jacket of the pre-insulated fitting,
installing a fitting internally in the mould, wherein the internal fitting forms the fitting through which medium flows in the pre-insulated fitting,
closing the end faces of the mould by means of closure caps,
introducing a liquid insulating material into the cavity formed between the inner contour of the mould, the closure caps and the internal fitting, and
removing the mould and the closure caps.

The method according to the preferred embodiment of the invention for producing a pre-insulated fitting includes:

providing a mould, wherein the mould has open end faces and an inner contour, wherein the inner contour corresponds to the fitting outer contour of a pre-insulated fitting, or of the end product. In order to produce the different shapes and sizes of the fittings, at least one mould that corresponds to the required fitting is preferably required in each case. It is advantageous for the fittings to be in the form of bends, T-pieces, angle pieces, straight coupling pieces, in each case for the connection of the same pipe diameters or in the form of reducers.

A coating is then applied to the inner contour of the mould, wherein the applied coating, after curing and demoulding, forms the outer jacket of the pre-insulated fitting. That is to say, on demoulding, the coating can be detached from the surface of the inner contour and forms a closed outer jacket of the pre-insulated fitting.

After application of the coating of the inner contour, an internal fitting is arranged in the mould, wherein the internal fitting forms the fitting through which medium flows in the pre-insulated fitting. The mould surrounds the internal fitting. The internal fitting preferably corresponds to the shape of the mould or of the pre-insulated fitting, that is to say, if the fitting will be a pre-insulated T-fitting, for example, the internal fitting has the shape of a T-piece. The mould is then closed at the end faces by means of closure caps. The end faces of the mould form the end faces of the pre-insulated fitting in all structural forms. As a result of the closure caps at the end faces, the mould and the internal fitting, a cavity forms therebetween, into which cavity the insulating material is introduced. To this end, liquid insulating material is introduced into the cavity that has been formed, and the liquid foam insulating material then cures. After curing, the closure caps and the mould are removed. Finishing work is then optionally carried out on the pre-insulated fitting.

Preferably, the mould is formed by two mould halves located opposite one another. Preferably, the mould halves are symmetrical. The parting plane of the two mould halves that are clamped together to form the mould preferably runs along the centre axis, or the centre axis lies in the parting plane. Preferably, the mould halves comprise a rigid and stable material.

In a preferred embodiment of the method according to the invention, the applied coating is applied to a silicone-containing inner contour. This ensures good detachment from the mould on demoulding of the pre-insulated fitting, so that the coating forms the outer jacket of the pre-insulated fitting after demoulding.

Preferably, the mould half is formed, inter alia, by a separator plate having an inner contour. To this end, the separator plate is placed into the mould half. It is advantageous for the separator plate to be fastened to the side of the mould half that faces inwards, and the two mould halves, which preferably each have an internal separator plate as a component, form the mould. Preferably, the inside of the mould half is covered completely by the separator plate having an inner contour.

It is advantageous for the mould half to be formed by a carbon-fibre-reinforced outer layer and for the inner contour to be formed by a separator plate made of silicone. The outer layer imparts the required rigidity and stability to the mould half, and the separator plate of silicone permits simple demoulding of the pre-insulated fitting, or detachment of the coating from the inner contour of the mould.

The preferred material that is applied for the coating of the inner contour is a liquid polyurea. This permits good demoulding and subsequently forms a tight outer jacket which satisfies the requirements and is of thin-walled form.

It has been found to be advantageous for the liquid insulating material to be formed by a polyurethane foam. This material meets the requirements of a good insulation and, owing to its liquid form, can easily be introduced into the cavity by means of a hose, which is introduced at the mould or closure cap, and then cures, whereupon the mould and the closure caps can be removed.

It has been found to be advantageous for the coating to be applied to the inner contour by spraying or brush coating. It must be ensured that the coating is applied sufficiently thickly for a certain degree of stability and continuously without gaps, in order that a closed outer jacket is formed.

Preferably, the internal fitting is arranged concentrically in the mould. his ensures that the cavity extends uniformly and thus also that the insulation layer is of equal thickness throughout.

It has been found to be preferred for the closure caps to be arranged at the ends of the internal fitting, whereby the internal fitting is centred relative to the inner contour of the mould and at the same time closes the end faces of the mould. It is advantageous for the closure caps to have a bore corresponding to the outside diameter of the internal fitting, said bore being pushed over the ends of the internal fitting and likewise serving to centre the internal fitting relative to the mould, or the mould halves. Before the liquid insulating material is introduced into the cavity, it is advantageous for the internal fitting and the mould to be aligned precisely relative to one another.

It is advantageous for the liquid insulating material to be introduced at the lowest-lying point and for the material to be pushed upwards or pumped in. In order to indicate whether the cavity is completely full, an indicator is to be provided at the uppermost point of the fitting, said indicator indicating when the insulating material has reached the uppermost point. Of course, this can also be achieved by a predetermined quantity of insulating material that is provided appropriately for the cavity, or by detecting the weight of the pre-insulated fitting.

It has also beenfound to be advantageous for an internal fitting with an outside diameter of ≥250 mm to be provided. It is advantageous for the method according to the invention to be used mainly for large pre-insulated fittings, since the smaller dimensions can still be produced on injection-moulding machines and the piece number of large dimensions tends to be small.

The pre-insulated fitting according to the invention is produced by the method according to the invention and comprises an outer jacket, which is formed by a cured coating, an internal fitting, and an insulation layer arranged therebetween.

All possible embodiments can freely be combined with one another and, in order to avoid repetition, the features of the apparatus also apply automatically to the method and vice versa.

### BRIEF DESCRIPTION OF THE DRAWINGS

An exemplary embodiment of the invention will be described with reference to the figures, the invention not being limited only to the exemplary embodiment. In the figures:

FIGS. 2a-2f show possible embodiments of a pre-insulated fitting according to the invention, the list not being exhaustive.

FIGS. 1a-1h show the steps of the production method, and

### DESCRIPTION OF THE PREFERRED EMBODIMENTS OF THE INVENTION

The images shown in FIGS. 1a-1f show, stepwise, the method according to the invention for producing a pre-insulated fitting 1 according to the invention. In FIG. 1a, the provision of the mould 2, which is preferably formed by two mould halves 3, is shown. The parting plane 4 runs along the centre axis 5, or the centre axis 5 lies in the parting plane 4 of the pre-insulated fitting 1. The mould 2 has two open end faces 6, which form the end faces in the fitting 1. In addition, the mould 2 has an inner contour 7, which corresponds to the outer contour of the pre-insulated fitting 1. It is advantageous for the mould halves 3 to be formed of a carbon-fibre-reinforced outer layer 9 and an internal separator plate 10 of silicone. A coating 12 is applied to the inner contour 7, which is shown in FIG. 1b. In the cured state on the pre-insulated fitting 1 according to the invention, the coating 12 forms the outer jacket 11 of the fitting 1. The coating 12 is preferably to be applied over the whole surface in order that the outer jacket 11 on the fitting 1 ensures its function of protecting the fitting 1. In FIG. 1c, the installation of the internal fitting 13 is shown. The fitting 1 shown here by way of example is a bend; the method according to the invention is of course possible for all types of fittings, and the installation of an internal T-fitting for a pre-insulated T-fitting is carried out either before the mould halves are closed to form a mould, or the internal T-fitting is removable or is mounted or joined to form the T-piece only in the mould. In order to form a closed cavity, which is filled with the insulating material, a closure cap 14 is fitted to the end face 6 in order to close the end face 6, see FIG. 1d. It is advantageous for a bore 17 corresponding to the outside diameter of the internal fitting 13 to be arranged in the closure cap 14, so that the closure cap 14 terminates optimally with the outside diameter and, in addition, the closure cap can preferably be used for adjusting the internal fitting 13 relative to the mould 2. Preferably, the internal fitting 13 is aligned relative to the mould 2 so that the internal fitting 13 is arranged concentrically and the cavity runs constantly and an insulation of equal thickness, if possible, is formed throughout. The liquid insulating material is then introduced into the cavity. In FIG. 1e it is shown that it is advantageous for the line 15, or the hose 15, for introduction to be provided at as low a position as possible, or at the lowest position, of the mould 2 and for the insulating material to be conveyed or pumped into the mould, so that voids in the insulation layer can be avoided. In order to indicate whether the cavity is completely full, an indicator 16 is to be provided at the uppermost point, as shown in FIG. 1f. After the insulating material has cured, the mould 2 is removed from the fitting 1, or the inner contour 7 is detached from the coating 12, which forms the outer jacket 11 of the pre-insulated fitting 1 according to the invention. FIG. 1g shows the fitting 1 already demoulded on one side, and FIG. 1h shows the pre-insulated fitting 1 according to the invention.

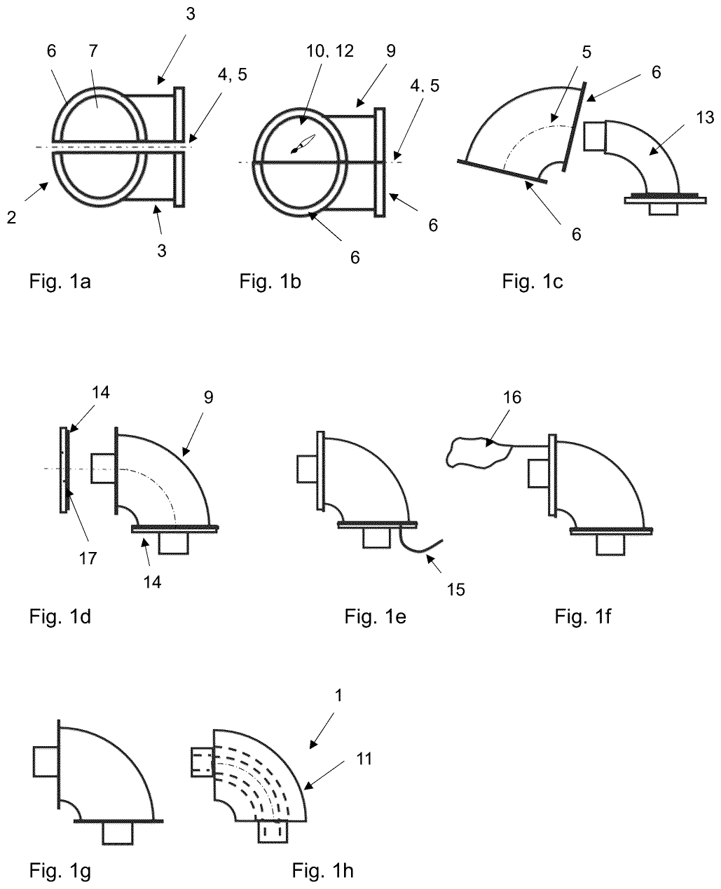

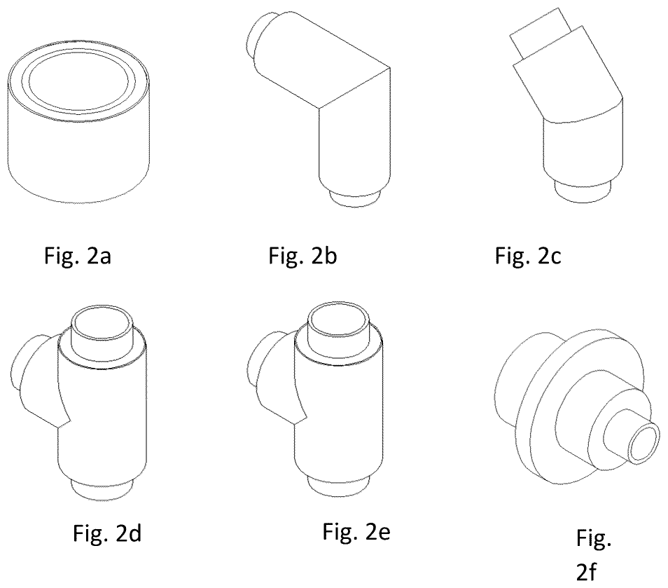

The fittings 1 according to the invention that are shown in FIGS. 2a to 2f are intended to show a pair of exemplary embodiments, this list is not being exhaustive. FIG. 2a shows a coupling element which is used for connecting two pipelines in a straight line with the same diameters. FIGS. 2b and 2c show deflections of 90° and 45°, which can also be implemented in the form of bends as can be seen in FIGS. 1a-1h. FIGS. 2d and 2e show T-pieces, wherein FIG. 2e shows a reducer. FIG. 2f shows a straight reducer in which a pipeline to be connected has a larger inside diameter than the opposite pipeline.

What is claimed is:

1. A method for producing a pre-insulated fitting (1), said method comprising:
providing a mould (2), wherein the mould (2) has open end faces (6) and an inner contour (7), wherein the inner contour (7) corresponds to the fitting outer contour (18) of a pre-insulated fitting (1),
applying a coating (12) to the inner contour (7), wherein the applied coating, after demoulding, (12) forms the outer jacket (8) of the pre-insulated fitting (1),
installing a fitting (13) internally in the mould (2), wherein the internal fitting (13) forms the fitting through which medium flows in the pre-insulated fitting (1),
closing the end faces (6) of the mould (1) by means of closure caps (14),
introducing a liquid insulating material into the cavity formed between the inner contour (7) of the mould (2), the closure caps (14) and the internal fitting (13), and
removing the mould (2) and the closure caps (14).

2. A method according to claim 1, wherein the mould (2) is formed by two mould halves (3) located opposite one another.

3. A method according to claim 1, wherein the coating (12) is applied to a silicone-containing inner contour (7).

4. A method according to claim 2, wherein the mould half (3) is formed, inter alia, by a separator plate (4) having an inner contour (7).

5. A method according to claim 2, the mould half (3) is formed by a carbon-fibre-reinforced outer layer and the inner contour (7) is formed by a separator plate (10) made of silicone.

6. A method according to claim 1, wherein the coating (12) of the inner contour (7) is formed by a liquid polyurea, which is applied.

7. A method according to claim 1, wherein the liquid insulating material is formed by a polyurethane foam.

8. A method according to claim 1, wherein the coating (12) is applied to the inner contour (7) by spraying or brush coating.

9. A method according to claim 1, wherein the internal fitting (13) is arranged concentrically in the mould.

10. A method according to claim 1, wherein the closure caps (14) are arranged at the ends of the internal fitting (13), whereby the internal fitting (13) is centred relative to the inner contour (7) of the mould (2) and at the same time closes the end faces (6) of the mould (2).

11. A method according to claim 1, wherein an internal fitting (13) with an inside diameter of ≥250 mm is provided.

12. A pre-insulated fitting (1) produced by the method according to claim 1, wherein the pre-insulated fitting (1) comprises an outer jacket (11), which is formed by a cured coating (12), an internal fitting (13), and an insulation layer arranged therebetween.
